(19) United States
(12) Patent Application Publication
(10) Pub. No.: US 2014/0032041 A1
(43) Pub. Date: Jan. 30, 2014

(54) ON-BOARD DIAGNOSIS UNIT FOR A MOTOR VEHICLE

(71) Applicants: Matthias Widmann, Ebersbach (DE); Bernd Schoellkopf, Uhingen (DE); Karl-Joerg Achenbach, Fellbach (DE)

(72) Inventors: Matthias Widmann, Ebersbach (DE); Bernd Schoellkopf, Uhingen (DE); Karl-Joerg Achenbach, Fellbach (DE)

(73) Assignee: DAIMLER AG, Stuttgart (DE)

(21) Appl. No.: 14/110,960

(22) PCT Filed: Dec. 9, 2011
(86) PCT No.: PCT/EP2011/006206

§ 371 Date: Oct. 10, 2013

(30) Foreign Application Priority Data
Apr. 16, 2011 (DE) 10 2011 017 324.2

(51) Int. Cl. F16L 25/01

(52) U.S. Cl. CPC F16L 25/01
USPC 701/34.4

(57) ABSTRACT

The invention proceeds from an on-board diagnosis unit for a motor vehicle for detecting a released mechanical connection between at least two fluidic lines (10, 11), having at least one first contact element (12, 13, 14) and at least one second contact element (15) which is spaced apart axially, of which contact elements (12, 13, 14, 15) at least one is provided for being deformed at least substantially elastically for making contact with at least one connecting point (16, 17, 18) of the mechanical connection. It is proposed that the on-board diagnosis unit has at least one third contact element (12, 13, 14) which is arranged spaced apart axially from the second contact element (15).

The invention relates to an on-board diagnostic unit according to the preamble of claim 1.

A diagnostic unit for recognizing a detached mechanical connection is known from DE 198 31 372 A1, having at least one first contact element and at least one axially spaced second contact element, of which at least one is provided for being deformed at least substantially elastically for contacting at least at at least one connecting point of the mechanical connection.

The object of the present invention in particular is to provide an inexpensive on-board diagnostic unit. This object is achieved according to the invention by the features of claim 1. Further embodiments result from the subclaims.

The invention is directed to an on-board diagnostic unit for a motor vehicle for recognizing a detached mechanical connection between at least two fluidic lines, having at least one first contact element and at least one axially spaced second contact element, of which at least one is provided for being deformed at least substantially elastically for contacting at least at at least one connecting point of the mechanical connection.

It is proposed that the on-board diagnostic unit has at least one third contact element which is situated at an axial distance from the second contact element. A simple and inexpensive on-board diagnostic unit may thus be provided by means of which a detachment of the two fluidic lines from one another may be easily diagnosed, so that a simple diagnostic system having reliable recognition of detached fluidic lines, in particular reliable recognition of the escape of blow-by gases, may be provided for a motor vehicle. In particular, particularly simple and reliable monitoring of multiple connections, and thus monitoring of multiple connecting points, may thus be implemented at the same time but separately from one another, so that an inexpensive on-board diagnostic unit may be provided by means of which in particular OBD requirements may be met. An “on-board diagnostic unit” is understood in particular to mean a unit which immediately signals an error to a driver and/or a mechanic of the motor vehicle, for example by means of an indicator light in the visual range of the driver and/or the mechanic, when there is an error, and thus a detached connection. “Contact element” is understood in particular to mean an electrical conductor which is preferably made of a metal. “Connecting point” is understood in particular to mean a point at which the two fluidic lines are joined together in particular in a positive-fit and/or force-fit manner, and/or which is provided in particular for accommodating at least one connecting element for the positive-fit and/or force-fit connection of the two fluidic lines. In the present context, the term “at least substantially elastically” is understood in particular to mean that a deviation from a purely elastic deformation in particular is less than 20%, preferably less than 10%, and particularly preferably less than 5%. In the present context, the term “axially spaced” is understood in particular to mean an axial distance between two contact elements with respect to the connecting point, and thus with respect to the connecting element. In the present context, the designations “first,” “second,” and “third” are understood in particular to denote a sequence of contact elements electrically arranged in series, according to which an electrical current flows through the at least three contact elements when the contact elements are viewed at one connecting point, in particular a first contact element being the contact element situated in front of the second contact element along a current flow, and the second contact element being the contact element situated in front of the third contact element along the current flow. The term “when the contact elements are viewed at one connecting point” is understood in particular to mean that, depending on which connecting point is viewed, the designation of the contact elements changes, so that when a next connecting point is viewed with regard to the current flow, a third contact element becomes a first contact element, and therefore the first contact element of the one connecting point and the third contact element of the other connecting point are formed as one piece, i.e., as the same component. The term “provided” is understood in particular to mean specially designed, equipped, and/or situated.

It is further proposed that the at least one first contact element and the at least one third contact element are situated at a peripheral distance from one another. The first contact element and the second contact element may thus be electrically decoupled from one another with a simple design, so that in particular the at least one connecting point may be monitored in a particularly simple manner. In the present context, “peripheral distance” is understood in particular to mean a distance between two contact elements about an axis of the connecting point, and thus about an axis of the connecting element, the two contact elements in particular being situated in the same plane.

In addition, it is proposed that the on-board diagnostic unit has at least one insulation element which in each case is situated partially between the axially spaced contact elements and is provided for electrically decoupling the axially spaced contact elements from one another. The axially spaced contact elements may thus be electrically decoupled from one another with a simple design. “Insulation element” is understood in particular to mean an electrical nonconductor. The term “situated between the axially spaced contact elements” is understood in particular to mean an axial configuration between the axially spaced contact elements.

Further advantages result from the following description of the drawings. One exemplary embodiment of the invention is illustrated in the drawings. The drawings, the description, and the claims contain numerous features in combination. Those skilled in the art will also advantageously consider the features individually and combine them into further meaningful combinations.

The figures show the following:

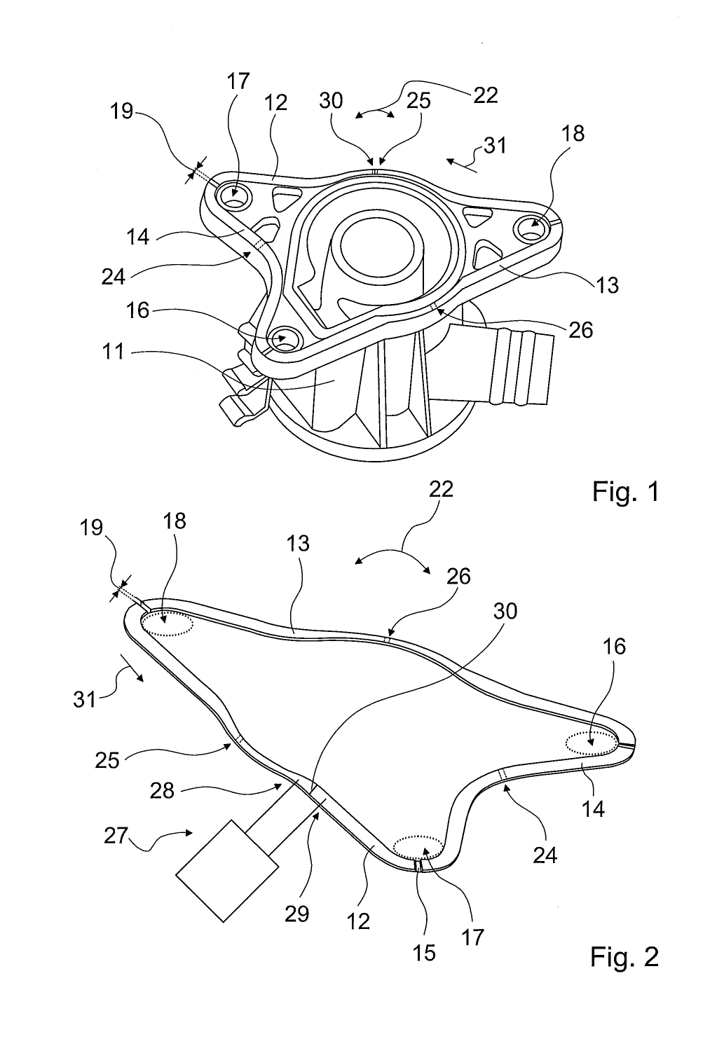

FIG. 1 shows an on-board diagnostic unit which is situated at a fluidic line,

FIG. 2 shows a schematic illustration of the on-board diagnostic unit together with a detection unit,

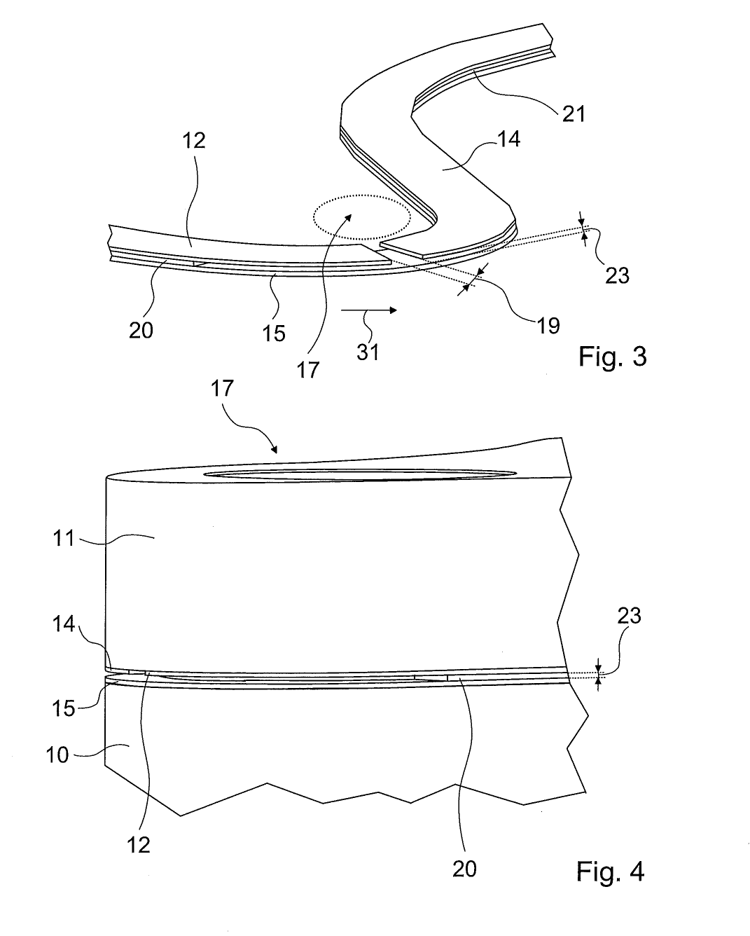

FIG. 3 shows an enlarged detail of the on-board diagnostic unit, and

FIG. 4 shows an enlarged detail of the on-board diagnostic unit, which is situated between two fluidic lines.

FIGS. 1 through 4 show an on-board diagnostic unit for a motor vehicle for recognizing a detached mechanical connection between at least two fluidic lines 10, 11. The fluidic lines 10, 11 are provided for discharging blow-by gases from an internal combustion engine of the motor vehicle. A blow-by gas flows through the lines. The two lines 10, 11 are tightly joined together by connecting elements of the mechanical connection, not illustrated in greater detail. The three connecting elements act on a respective connecting point 16, 17, 18 of the mechanical connection. These connecting elements act on a three-hole flange designed in one piece with the line 11. The connecting elements are designed as screws. Thus, the mechanical connection is formed as a screw connection. The fluidic line 11 is designed as an oil filler neck, and the fluidic line 10 is designed as a cylinder head cover. In principle, the mechanical connection may also be designed as a riveted joint or the like.

The on-board diagnostic unit has four contact elements 12, 13, 14, 15. For electrically decoupling the contact elements 12, 13, 14 from the contact element 15, the contact elements 12, 13, 14 are situated at an axial distance from the contact element 15. The contact elements 12, 13, 14 have an axial distance 23, i.e., a distance along the direction of flow of the blow-by gas, from the contact element 15. The contact elements 12, 13, 14 are situated in the same plane. The adjacent contact elements 12, 13, 14 are each situated at a peripheral distance 19 from one another for interrupting an electrical circuit along the contact elements 12, 13, 14. The peripheral distance 19 is provided as a distance between the adjacent contact elements 12, 13, 14 about the direction of flow of the blow-by gas, and thus about an axis of the connecting element, at the connecting point 16, 17, 18. The contact elements 12, 13, 14 which are adjacent along a peripheral direction 22, i.e., along a direction extending about a direction of flow of the blow-by gas, each have a distance from one another along the peripheral direction 22. The peripheral distance 19 of the adjacent contact elements 12, 13, 14 is situated at a connecting point 16, 17, 18, respectively. The peripheral distance 19 between the contact elements 13, 14 is situated at the connecting point 16, the peripheral distance 19 between the contact elements 12, 14 is situated at the connecting point 17, and the peripheral distance 19 between the contact elements 12, 13 is situated at the connecting point 18.

For interrupting the electrical circuit along the contact element 15, the contact element 15 has three decoupling points 24, 25, 26, each of which electrically decouples the contact element 15 along the peripheral direction 22. The decoupling point 24 is situated along the peripheral direction 22 between the connecting points 16, 17, the decoupling point 25 is situated between the connecting points 17, 18, and the decoupling point 26 is situated between the connecting points 16, 18. The contact elements 12, 13, 14, 15 each have a strip-shaped design, i.e., have a main direction of extension which is significantly greater than their width. The contact elements 12, 13, 14, 15 each have a main direction of extension which is at least 5 times, advantageously at least 10 times, particularly advantageously at least 20 times, larger than the respective width. The contact elements 12, 13, 14, 15 are each designed as a contact plate. In the present exemplary embodiment, the contact elements 12, 13, 14, 15 each have a thickness, and thus an axially extending height, of 0.1 mm. In principle, the contact element 15 for interrupting the electrical circuit may also have a multipart design, analogously to the contact elements 12, 13, 14, so that the multipart contact element 15 in each case likewise would have a peripheral distance between adjacent individual parts of the contact element 15, which would be situated between two respective connecting points 16, 17, 18.

For contacting the axially spaced contact element 15, the contact elements 12, 13, 14 at a respective connecting point 16, 17, 18 of the mechanical connection are provided for being elastically deformed. For contacting the contact element 15, the contact elements are each provided for being elastically deformed in an area of the peripheral distance 19. The contact elements 12, 13, 14 are elastically deformed at their respective ends by a connecting force of the mechanical connection, which is designed as a screw connection, and thus by the connecting elements, and at the ends are pressed against the contact element 15 so that they contact the contact element 15. Of course, the individual parts of a multipart contact element 15 may also be designed as short contact elements, each of which is axially spaced at the peripheral distance 19 of the adjacent contact elements 12, 13, 14, and whose main direction of extension specifically has a value so that the contact elements 12, 13, 14 contact the corresponding individual part of the multipart contact element 15 due to the elastic deformation. For strength reasons, however, the above-described strip-shaped design of the contact element 15 is preferred.

For achieving the axial distance 23, the on-board diagnostic unit has three insulation elements 20, 21, one insulation element not being visible in FIGS. 3 and 4. For electrically decoupling the axially spaced contact elements 12, 13, 14, 15, the insulation elements 20, 21 are partially situated between the axially spaced contact elements 12, 13, 14, 15. The insulation element 20 is axially situated between the contact element 15 and the contact element 12, the insulation element 21 is axially situated between the contact element 15 and the contact element 14, and the insulation element which is not visible is axially situated between the contact element 15 and the contact element 13. The insulation elements 20, 21, analogously to the contact elements 12, 13, 14, likewise have a peripheral distance, the peripheral distance of the insulation elements 20, 21 being greater than the peripheral distance 19. The peripheral distance of the insulation elements 20, 21 is situated in each case at a connecting point 16, 17, 18, and thus at a peripheral distance 19 of the contact elements 12, 13, 14, so that the contact elements 12, 13, 14 are able to contact the contact element 15 with their ends due to the connecting force of the mechanical connection. The insulation elements 20, 21 are each glued between the axially spaced contact elements 12, 13, 14, 15. The insulation elements 20, 21 have an elastic design, and are each provided as an elastomer. In principle, the insulation elements 20, 21 may also be injected between the respective contact elements 12, 13, 14, 15. In the present exemplary embodiment, the insulation elements 20, 21 each have a thickness, and thus an axially extending height, of 0.2 mm. In an unloaded state of the insulation elements 20, 21, each of the contact elements 12, 13, 14 thus has an axial distance 23 of 0.2 mm from the contact element 15.

The contact elements 12, 13, 14, 15 and the insulation elements 20, 21 of the on-board diagnostic unit have the same course. The contact elements 12, 13, 14, 15 and the insulation elements 20, 21 are situated between the two lines 10, 11. The contact elements extend along the peripheral direction 22 around all three connecting points 16, 17, 18, and extend outside the three-hole flange. The contact elements 12, 13, 14, 15 and the insulation elements 20, 21 surround the three connecting points 16, 17, 18. In principle, the contact elements 12, 13, 14, 15 and the insulation elements 20, 21 may also be situated between one of the lines 10, 11 and the connecting elements.

The on-board diagnostic unit has a detection unit 27 for separate monitoring of all three connecting points 16, 17, 18, and thus for recognizing a detached, defective, or incorrectly attached connecting element of the mechanical connection. For supplying the electrical current flow, the detection unit 27 is provided for applying a measuring voltage to only one of the contact elements 12, 13, 14. In the present exemplary embodiment, the detection unit 27 applies the measuring voltage only to the contact element 12. For this purpose, the detection unit 27 has two electrical poles 28, 29 which are electrically connected to the contact element 12. To avoid a direct current flow between the two poles 28, 29, the contact element 12 has an electrical decoupling 30 between the two poles 28, 29. A current, by way of example, can flow only when all ends of the contact elements 12, 13, 14 contact the contact element 15 due to the connecting force of the mechanical connection, and thus when all connecting elements, which are designed as screws, are tightened, thus forming a closed circuit. The contact element 15 is used as an electrical bridge between two adjacent contact elements 12, 13, 14 in each case, which for this purpose electrically connects each of the two ends of the contact elements 12, 13, 14 separated by the peripheral distance 19. The current flows from each contact element 12, 13, 14 to the contact element 15, and from the contact element 15 further flows to the corresponding adjacent contact element 12, 13, 14.

Even if only one of the ends of the contact elements 12, 13, 14 is situated at a distance from the contact element 15 and thus no longer makes contact, the circuit between the poles 28, 29 is interrupted and thus opened, so that the detection unit 27 recognizes a detached connection. The detection unit 27 signals the detached connection via an indicator light, mounted in the passenger compartment of the motor vehicle, of the on-board diagnostic unit, so that a fault in the connection may be recognized early and therefore damage may be reduced. The connection of the line 11 designed as an oil filler neck to the line 12 designed as a cylinder head cover is thus monitored, so that escape of the blow-by gas is prevented and a correct installation may be checked. In principle, the contact element 12 for avoiding the direct current flow between the two poles 28, 29 may also have a two-part design, and thus have a peripheral distance situated between the two poles 28, 29, thereby replacing the electrical decoupling 30.

The mode of operation of the on-board diagnostic unit at the connecting point 17 is explained in greater detail below (in this regard, see in particular FIG. 3). For recognizing the detached connecting element, designed as a screw, in the connecting point 17 between the two fluidic lines 10, 11, the on-board diagnostic unit has the first contact element 12 and the second contact element 15, which is situated at an axial distance from the first contact element 12, of which the contact element 12 is provided for contacting the contact element 15 at the connecting point 17 via the connecting element, and thus being elastically deformed by means of the connecting force of the mechanical connection. The on-board diagnostic unit also includes the third contact element 14, which is situated at an axial distance from the second contact element 15. The first contact element 12 and the third contact element 14 are situated in the same plane. For contacting the contact element 15 at the connecting point 17, the third contact element 14 is likewise provided for being elastically deformed by the connecting element of the mechanical connection, so that a current may flow from the first contact element 12, via the second contact element 15, to the third contact element 14. The current has a current direction 31. The second contact element 15 is used as an electrical bridge, which for closing the circuit electrically connects the two ends of the contact elements 12, 14 separated by the peripheral distance 19. The designations “first,” “second,” and “third” represent a direction of flow of the current, the current initially flowing along the first contact element 12, then along the second contact element 15, and finally, along the third contact element 14.

Of course, the designation may change, for example in the event of a pole reversal of the detection unit 27. In the process, the current direction 31 changes, so that the contact element 14 is provided as the first contact element 14 and the contact element 12 is provided as the third contact element 12. The mode of operation at the other connecting points 16, 18 is analogous, with the designations “first” and “third” shifted. For the current direction 31, the contact element 14 at the connecting point 16 is then provided as the first contact element 14, and the contact element 13 is provided as the third contact element 13.

1. An on-board diagnostic unit for a motor vehicle for recognizing a detached mechanical connection between at least two fluidic lines (10, 11), having at least one first contact element (12, 13, 14) which is an electrical conductor, and at least one axially spaced second contact element (15) which is an electrical conductor, of which at least one is provided for being deformed at least substantially elastically for contacting at least at at least one connecting point (16, 17, 18) of the mechanical connection,
further comprising at least one third contact element (12, 13, 14) which is an electrical conductor and which is situated at an axial distance from the second contact element (15), the third contact element (14) being provided for being elastically deformed for contacting the contact element (15) at the connecting point (16, 17, 18) so that a current may flow from the first contact element (12), via the second contact element (15), to the third contact element (14).

2. The on-board diagnostic unit according to claim 1,
wherein the at least one first contact element (12, 13, 14) and the at least one third contact element (12, 13, 14) are situated in the same plane, and for interrupting an electrical circuit are situated at a peripheral distance (19) from one another which extends around the at least one connecting point (16, 17, 18).

3. The on-board diagnostic unit according to claim 1,
comprising at least one insulation element (20, 21) which is an electrical nonconductor and which in each case is situated partially between the axially spaced contact elements (12, 13, 14, 15) and is provided for electrically decoupling the axially spaced contact elements (12, 13, 14, 15) from one another.

4. The onboard diagnostic unit according to claim 2, wherein the first contact element (12, 13, 14) has an end which is situated opposite from an end of the third contact element (12, 13, 14), whereby the contact elements (12, 13, 14) are elastically deformable at their respective ends by a connecting force of the mechanical connection, and may thus be pressed against the axially spaced second contact element (15).

5. The onboard diagnostic unit according to claim 4, wherein the second contact element (15) is used as an electrical bridge, which for closing the electrical circuit electrically connects the two ends of the contact elements (12, 13, 14) separated by the peripheral distance (19).

6. The onboard diagnostic unit according to claim 5, further comprising a detection unit (27) which for applying a measuring voltage has two electrical poles (28, 29) which are electrically connected to one of the contact elements (12).

7. The onboard diagnostic unit according to claim 6, wherein the detection unit (27) recognizes a detached connection when the electrical circuit is interrupted due to an absent contact between one of the ends of the contact elements (12, 13, 14) and the axially spaced second contact element (15).

8. The onboard diagnostic unit according to claim 2, wherein the contact elements (12, 13, 14) each have a strip-shaped design.
